(19) United States
(12) Patent Application Publication
(10) Pub. No.: US 2015/0160841 A1
(43) Pub. Date: Jun. 11, 2015

(54) DESKTOP-LIKE DEVICE AND METHOD FOR DISPLAYING USER INTERFACE

(71) Applicant: Acer Incorporated, New Taipei City (TW)

(72) Inventor: Yung-Ting Chang, New Taipei City (TW)

(73) Assignee: Acer Incorporated, New Taipei City (TW)

(21) Appl. No.: 14/254,262

(22) Filed: Apr. 16, 2014

(30) Foreign Application Priority Data
Dec. 9, 2013 (TW) 102145072

(51) Int. Cl. G06F 3/0484; G06F 3/00; G06F 3/0487; G06T 3/60; G06F 3/0481

(52) U.S. Cl. CPC G06F 3/04845; G06T 3/60; G06F 3/04817; G06F 3/0487; G06F 3/005

(57) ABSTRACT

The invention provides a desktop-like device, including a detecting unit, a display unit and a processing unit. The detecting unit detects an attitude of the desktop-like device, and a first display mode of user interface. The first display mode provides a first long axis and a first short axis, and the first long axis is in predetermined proportion to the first short axis. The display unit provides a second long axis and a second short axis, and the user interface is shown in a display area by the first display mode. The processing unit determines whether the first display mode is compatible with the attitude or not. If the first display mode is not compatible with the attitude, the first display mode will be displayed in the display area in predetermined proportion, and the first long axis will be equivalent to the second short axis.

### CROSS REFERENCE TO RELATED APPLICATIONS

This application claims priority of Taiwan Patent Application No. 102145072, filed on Dec. 9, 2013, the entirety of which is incorporated by reference herein.

### BACKGROUND OF THE INVENTION

1. Field of the Invention

The application relates in general to a desktop-like device and a method for displaying a user interface, and in particular to a method for displaying the user interface with different display modes on a desktop-like device which has a fixed attitude.

2. Description of the Related Art

These days, due to the rapid development of technology, larger screens with better performance. However, the operations available to the user are limited by increases in screen size. For example, the user cannot easily alter the display direction of the screen just as with a portable electronic device. The difficulty of moving the large electronic device make it inconvenient to run certain applications that require changing from either a vertical or horizontal display orientation. Thus, finding a way to successfully operate the user interface on a large electronic device is a problem which needs to be solved.

### BRIEF SUMMARY OF INVENTION

An embodiment of the invention provides a desktop-like device, including a detecting unit, a display unit and a processing unit. The detecting unit is arranged to detect an attitude of the desktop-like device, and a first display mode of the user interface. The first display mode provides a first long axis and a first short axis, and the first long axis is in predetermined proportion to the first short axis. The display unit provides a second long axis and a second short axis, and the user interface is shown in a display area by the first display mode. The processing unit is arranged to determine whether the first display mode is compatible with the attitude or not. If the first display mode is not compatible with the attitude, the first display mode will be displayed in the display area in predetermined proportion, and the first long axis will be equivalent to the second short axis. Further, the first long axis and the second short axis are parallel to each other.

Another embodiment of the invention provides a method for displaying a user interface. The method is adapted to a desktop-like device. The steps of the method comprise detecting the attitude of the desktop-like device; determining whether the first display mode of the user interfate is compatible with the attitude or not (the first display mode provides a first long axis and a first short axis, and the first long axis is in predetermined proportion to the first short axis); if the first display mode is not compatible with the attitude, the first display mode will be adjusted so that it is equivalent to the second short axis according to a predetermined proportion; and displaying the user interface in the display area with the first display mode.

### BRIEF DESCRIPTION OF DRAWINGS

The invention can be more fully understood by reading the subsequent detailed description and examples with references made to the accompanying drawings, wherein:

FIG. 1 is a block diagram of a desktop-like device in accordance with an embodiment of the invention;

FIGS. 2A and 2B are schematic drawings for displaying an error display of the user interface in accordance with an embodiment of the invention;

FIGS. 3A and 3B are schematic drawings for displaying a user interface in accordance with an embodiment of the invention;

FIGS. 4A and 4B are schematic drawings for displaying a user interface in accordance with another embodiment of the invention;

FIGS. 5A and 5B are schematic drawings for displaying a user interface in accordance with another embodiment of the invention;

FIGS. 6A and 6B are schematic drawings for displaying a user interface in accordance with another embodiment of the invention;

FIG. 7 is a schematic drawing for switching a user interface in accordance with another embodiment of the invention; and

FIG. 8 is a flow chart of a method for displaying a user interface in accordance with an embodiment of the invention.

### DETAILED DESCRIPTION OF INVENTION

Further areas of applicability of the present devices and methods will become apparent from the detailed description provided hereinafter. It should be understood that the detailed description and specific examples, while indicating exemplary embodiments of the desktop-like devices and the methods for displaying user interface, are intended for purposes of illustration only and are not intended to limit the scope of the invention.

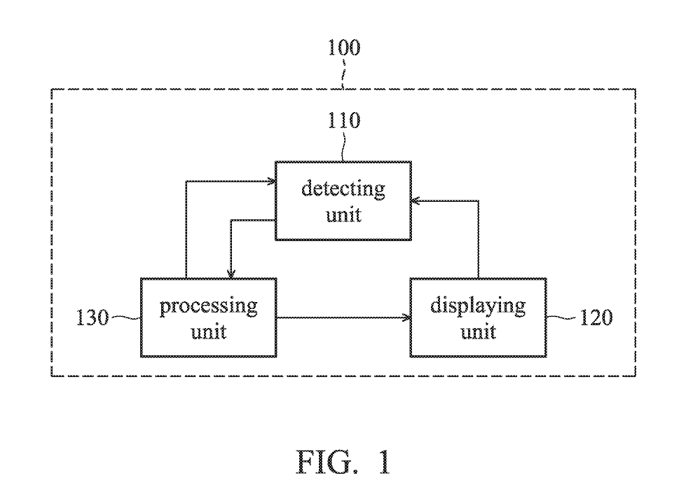

FIG. 1 is a block diagram of a desktop-like device in accordance with an embodiment of the invention. As shown in FIG. 1, the desktop-like device 100 includes a detecting unit 110, a display unit 120 and a processing unit 130. The desktop-like device 100 can be a large tablet with a touch display unit or a desktop computer, etc. It should be noted that the desktop-like device further includes a memory unit, a storage unit, and other components, and since the characteristics of these components are similar to those in the prior art, they will not be described herein.

The detecting unit is arranged to detect the attitude of the desktop-like device 100, and a first display mode of the user interface. The attitude includes vertical screen and horizontal screen, and the first display mode provides landscape mode and portrait mode. The first display mode provides a first long axis and a first short axis, and the first long axis is in predetermined proportion to the first short axis. For example, the first display mode displays the user interface in portrait mode. The display unit 120 provides a second long axis and a second short axis, and the user interface is shown in a display area with the first display mode. The processing unit 130 is arranged to determine whether the first display mode is compatible with the attitude or not, which means the attitude of the display unit 120 is the same as the first display mode. For example, the display unit 120 is a vertical screen, and the first display mode is portrait mode. On the other hand, the display unit 120 is a horizontal screen, and the first display mode is portrait mode. If the first display mode is not compatible with the attitude, (in other words, if the attitude is different from the display direction by 90 degrees), the first display mode will be displayed in the display area in predetermined proportion, and the first long axis will be equivalent to the second short axis. Furthermore, the first axis and the second short axis are parallel to each other.

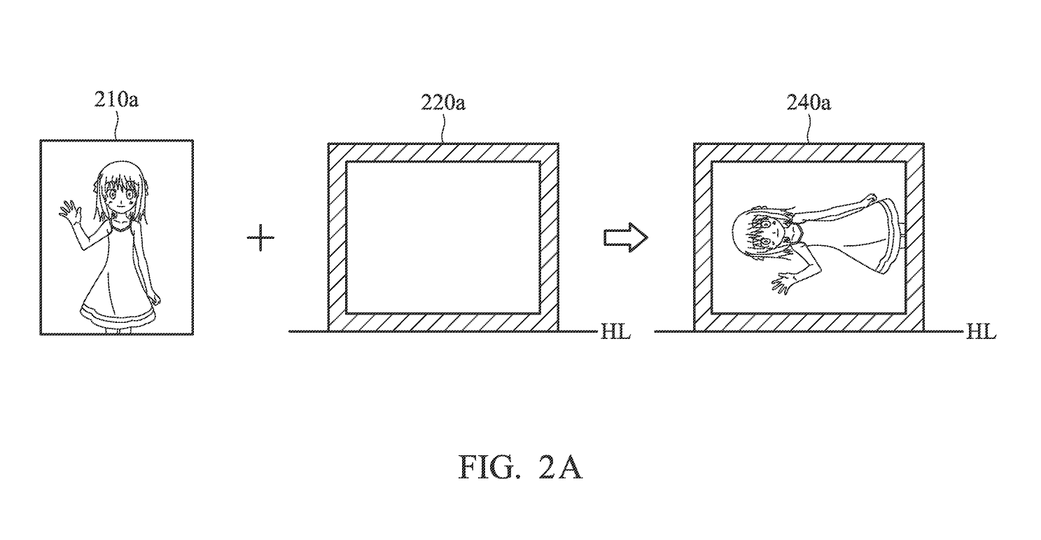

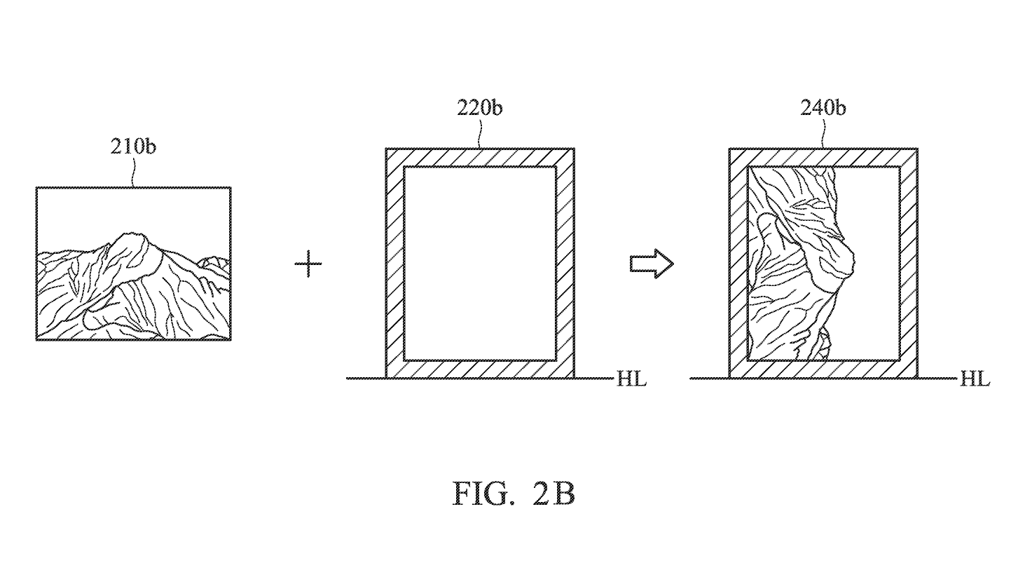

FIGS. 2A and 2B are schematic drawings for displaying an error-display of the user interface in accordance with an embodiment of the invention. When the display direction of the user interface is not compatible with the display unit, the user interface will be displayed in wrong direction. As shown in FIG. 2, the user interface 210a should be shown in portrait mode, but it is now in portrait mode (shown as display result 240b). The direction of the words or the content of the figure will be different from the reading direction due to the display result, and it might be inconvenient to use. In view of this, the present invention provides a device and a method for solving the problem.

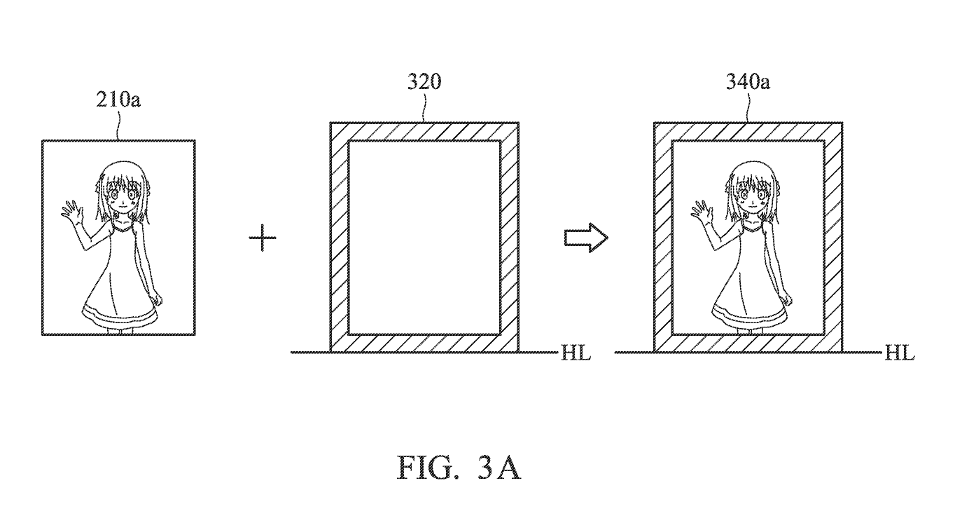

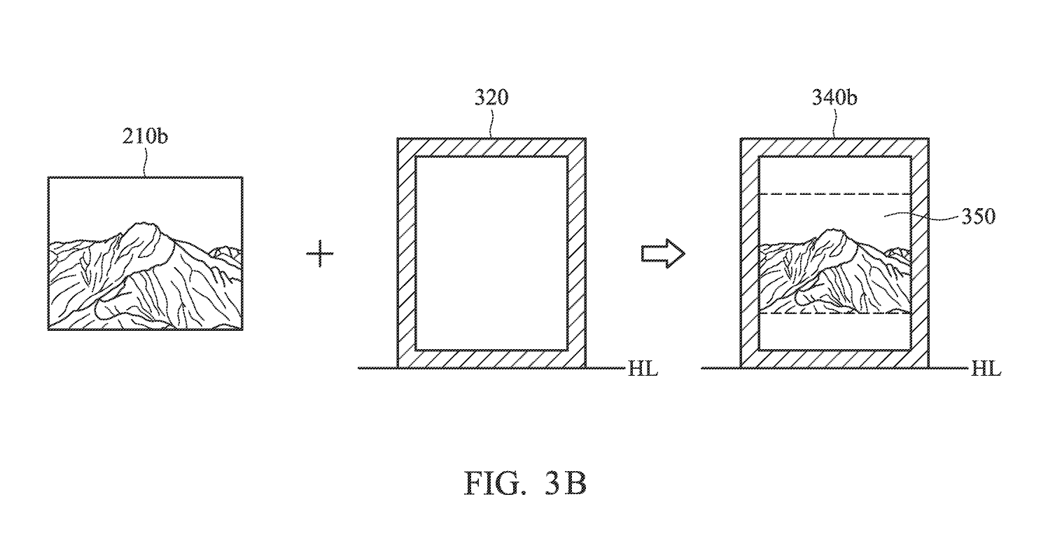

FIGS. 3A and 3B are schematic drawings for displaying a user interface in accordance with an embodiment of the invention. As shown in FIGS. 3A and 3B, the display unit 320 is placed on the desk with a vertical screen (which means the short axis of the display unit 320 is parallel to the level line HL). Please refer to FIG. 3A: when the user implements a user interface 210a, the display unit 320 detected by the detecting unit 110 is vertical screen and the display mode of the user interface 210a is portrait mode. Then, the processing unit 130 determines that the first display mode of the user interface 210a is compatible with the display unit 320. After that, the processing unit 130 will adjust the resolution of the user interface 210a to make it similar to or the same as the resolution of the display unit 320. The adjusted user interface 210a will be displayed in the display unit 320 (shown as display result 340a).

However, when the detecting unit 110 detects that the attitude of the display unit 320 is different from the first display mode of the user interface 210b, the display mode of the user interface 210b will be adjusted by the processing unit 130. For instance, as shown in FIG. 3B, the display unit 320 is a vertical screen, and the first display mode of the user interface 210b is landscape mode. The processing unit 130 will program a display area 350 according to the predetermined proportion, the predetermined proportion is defined by the first long axis and the first short axis of the first display mode of the user interface 210b. For example, the size of the first display mode of the user interface 210b is 1280dp×960dp, and the predetermined proportion is 4:3. If the second short axis of the display unit 320 is 960dp, the processing unit 130 will program a display area 350 with a size of 960dp×720dp according to the length of the second short axis. The first display mode will adjust the length of the first long axis to 960dp or smaller, according to the display area 350, for showing the complete and correct user interface in the display area 350 (shown as display result 340b in FIG. 3B). Otherwise, the first short axis will be adjusted to 720dp or smaller, according to the length of first long axis by the predetermined proportion (for example, according to the predetermined proportion of 4:3 as described). It should be noted that, because the mode of some applications will be altered according to the attitude of the device, the first display mode as described above is defined as the predetermined display mode when enabling the user interface.

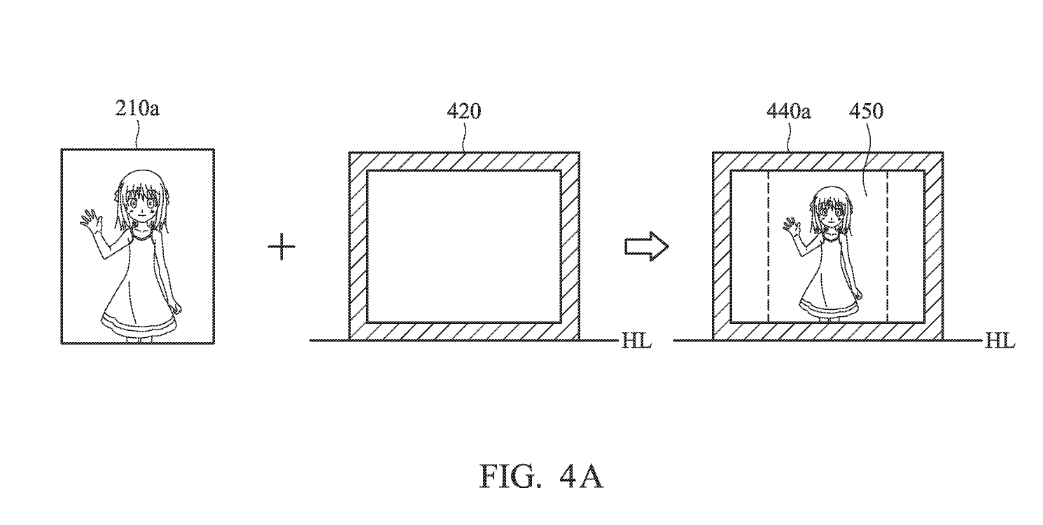

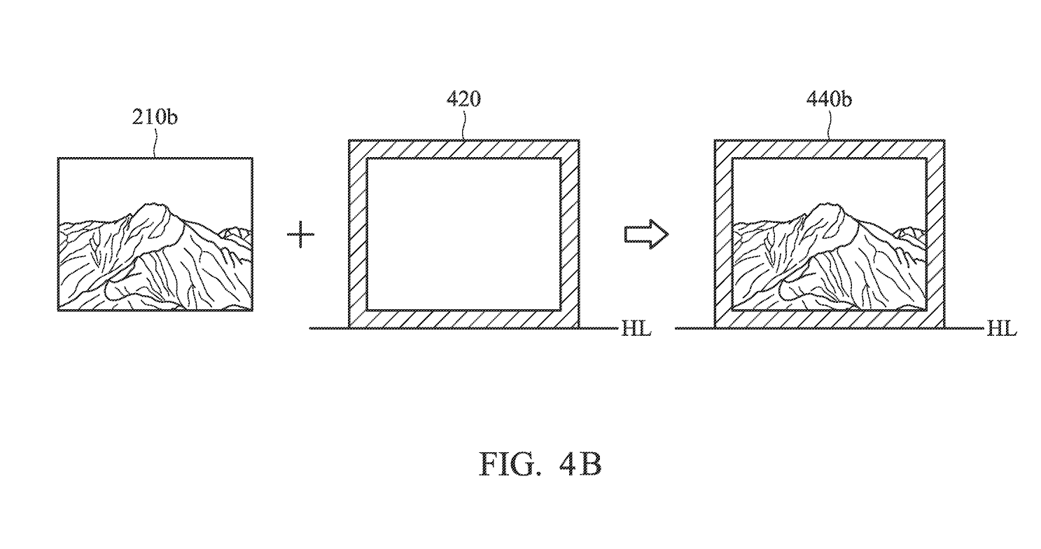

FIGS. 4A and 4B are schematic drawings for displaying a user interface in accordance with another embodiment of the invention. As shown in FIGS. 4A and 4B, the display unit 420 is placed on the desk with horizontal screen (which means the long axis of the display unit 420 is parallel to the level line HL). Please refer to FIG. 4A, when user implements a user interface 210a, the detecting unit 110 detects the display unit 420 is horizontal screen and the display mode of the user interface 210a is in portrait mode, in other words, the first display mode of the user interface 210a is not compatible with the attitude of the display unit 420. The display mode of the user interface 210b will be adjusted by the processing unit 130. For instance, the size of the first display mode of the user interface 210a is 960dp*1280dp, and the predetermined proportion is 3:4. The second short axis if the display unit 320 is 960dp, the processing unit 130 will program a display area 450 with a size of 720dp*960dp according to the length of the second short axis. The first display mode will adjust the length of the first long axis to 960dp or smaller than 960dp according to the display area 450. Otherwise, the first short axis will be adjusted to 720dp or smaller than 720dp according to the length of first long axis by the predetermined proportion (for example, according to the predetermined proportion of 3:4 as described).

Please refer to FIG. 4B. When the user implements a user interface 210b, the detecting unit 110 detects the display unit 420 is horizontal screen and the display mode of the user interface 210b is in landscape mode. Then, the processing unit 130 determines the first display mode of the user interface 210b is compatible with the display unit 420. The following step is similar to that in FIG. 3A, and therefore it will not be described again.

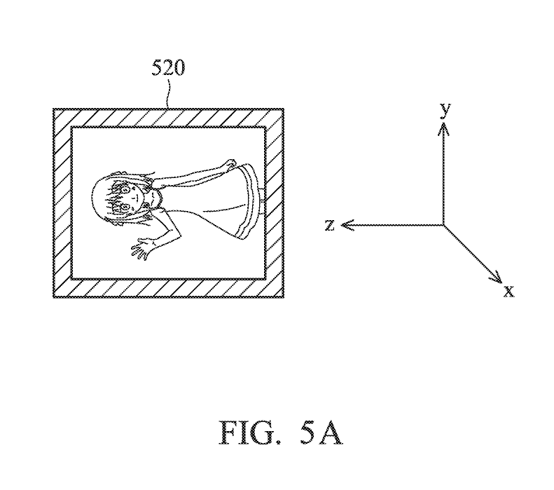

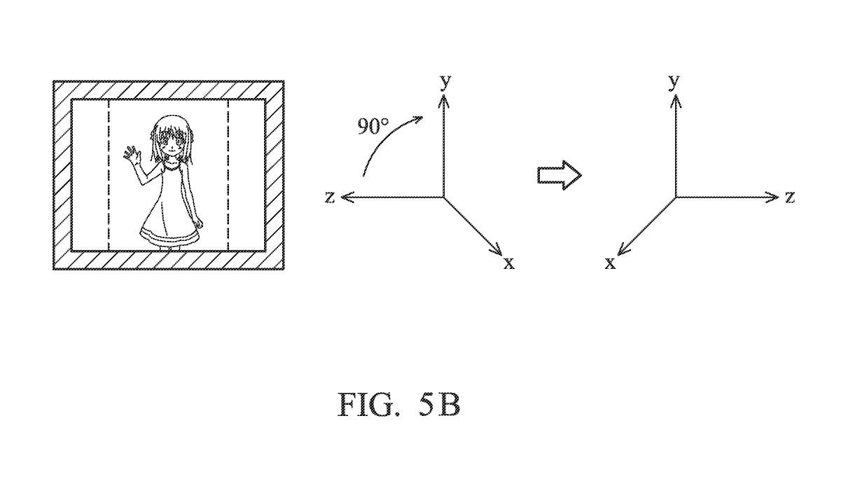

FIG. 5A, 5B are schematic drawings for displaying a user interface in accordance with another embodiment of the invention. The desktop-like device 100 further includes a sensing unit (not shown). As shown in FIG. 5A, before adjusting the display direction of the first display mode, the attitude of the display unit 520 is horizontal screen, and the first display mode of the user interface is shown in portrait mode (as shown at the left side of FIG. 5). Then, due to the display direction of the first display mode of the user interface being different from the attitude of the display unit 520, the x-axis, y-axis and z-axis of the sensor will be rotated 90 degrees before the adjustment of the processing unit 130 to match the wrong display direction. The wrong display direction means the first display mode of the user interface, which is portrait mode, is rotated clockwise or counter clockwise 90 degrees and displayed in the horizontal screen. However, as shown in FIG. 5B, after the first display mode has been shown in the right display direction, the x-axis, y-axis and z-axis of the sensor will be returned to the state before the rotation, and the extracted data will be directly transmitted back to the user interface for obtaining the correct data.

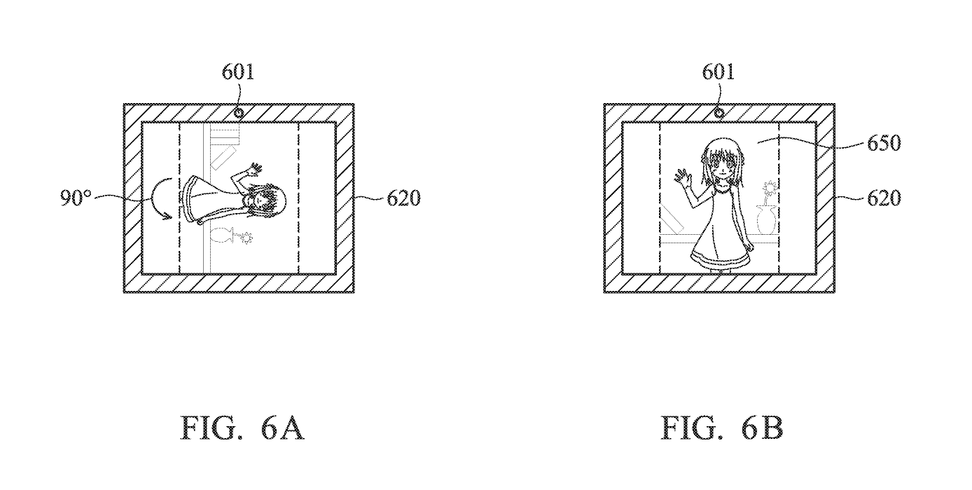

Please refer to FIG. 6A, 6B. FIG. 6A, 6B are schematic drawings for displaying a user interface in accordance with another embodiment of the invention. The desktop-like device 100 further includes a video lens. As shown in FIG. 6A, before adjusting the display direction of the first display mode, the attitude of the display unit 620 is horizontal screen, and the first display mode of the user interface is shown in portrait mode. Then, due to the display direction of the first display mode of the user interface is different from the attitude of the display unit 520, the image extracted from the video lens will be clockwise or counterclockwise rotated in 90 degrees before the adjustment for matching the wrong display direction. However, as shown in FIG. 6B, after the first display mode displayed in the right display direction, the extracted image will be revised according to the proportion of the display area 650 and the display unit 120 by the processing unit 130, rotated 90 degrees counterclockwise or clockwise rotated, and enlarged to match the size of the display unit 650 for displaying the correct image.

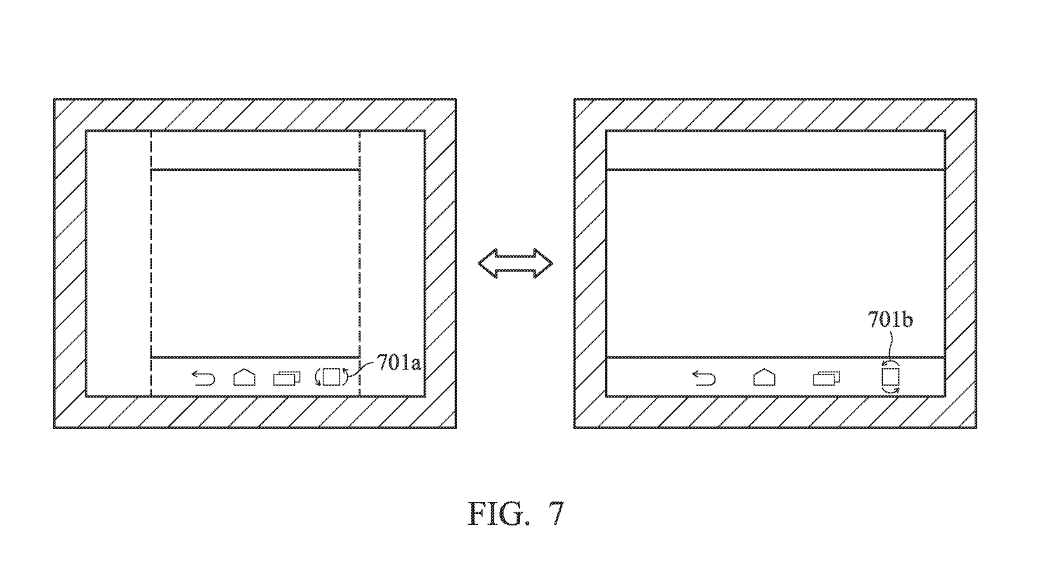

Please refer to FIG. 7. FIG. 7 is a schematic drawing for switching a user interface in accordance with another embodiment of the invention. When the user interface provides the first display mode (as shown on the left side of FIG. 7) and the second display mode (as shown on the right side of FIG. 7), the processing unit 130 switches the display mode according to the enabling of an icon by the user. For example, for matching the horizontal screen and vertical screen of the display unit, some of the user interface might have two kinds of display modes. However, in some specific situations, the display mode for matching the attitude of the display unit might reduce the operating convenience for the user, thus, the user interface includes the icon 701a or the icon 701b to switch between different display modes. As shown in the left side of FIG. 7, when the user interface is shown in portrait mode, the user interface includes the icon 701a for hinting to the user that the user interface has two different kinds of display modes, and the display mode can be switched to another display mode by enabling the icon 701a (as shown in the right of FIG. 7). On the other hand, when the user interface is shown in landscape mode, the user interface includes the icon 701b, and the user can enable the icon 701b to switch the display mode to portrait mode.

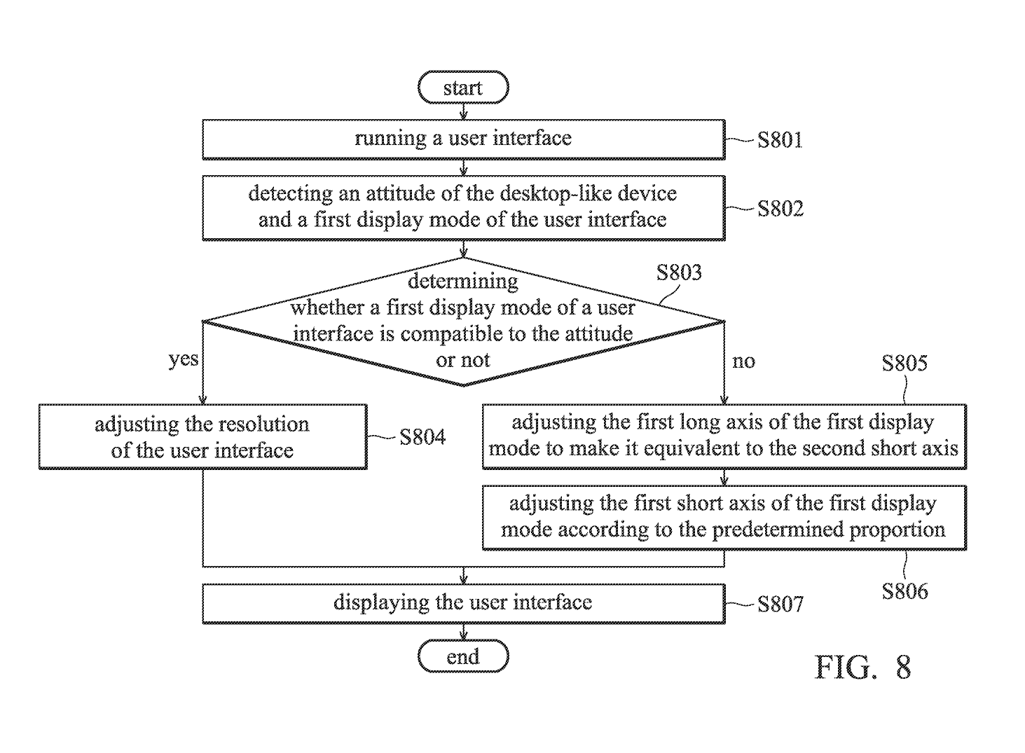

FIG. 8 is a flow chart of a method for displaying a user interface in accordance with an embodiment of the invention. Please refer FIG. 8 with FIG. 1. First, detecting an attitude of the desktop-like device (step S801). The desktop-like device 100 can be a large tablet with a touch display unit or a desktop computer, etc. In step S802, the processing unit 130 determines whether the first display mode of the user interface is compatible with the attitude or not. The attitude includes a vertical screen and horizontal screen, and the first display mode provides landscape mode and portrait mode. The first display mode provides a first long axis and a first short axis, and the first long axis is in predetermined proportion to the first short axis. It should be noted that the first display mode of the user interface is compatible with the attitude means that the attitude of the display unit 120 is same as the display of the first display mode. For example, the display unit 120 is a vertical screen, and the first display mode is shown in portrait mode. Otherwise, the display unit 120 is a horizontal screen, and the first display mode is shown in portrait mode.

If the first display mode is compatible with the attitude, then the method proceeds to step S804, adjusting the resolution of the user interface to make it similar to or the same as the resolution of the display unit 120. The adjusted user interface will be displayed in the display unit 120 (step S807).

If the first display mode is not compatible with the attitude, the first display mode will be adjusted by the processing unit 130. For example, the display unit 120 is vertical screen, and the first display mode of the user interface is shown in landscape mode. The processing unit 130 will program a display area according to the predetermined proportion, the predetermined proportion is defined by the first long axis and the first short axis of the first display mode of the user interface (step S805). For example, the size of the first display mode of the user interface is 1280dp*960dp, and the predetermined proportion is 4:3. The second short axis if the display unit 120 is 960dp, the processing unit 130 will program a display area with a size of 960dp*720dp according to the length of the second short axis. The first display mode will adjust the length of the first long axis to 960dp or smaller than 960dp according to the display area, and the first short axis will be adjusted according to the length of first long axis by the predetermined proportion (step S806). Finally, in step S807, showing the complete and correct user interface in the displaying area.

The desktop-like device 100 further includes a sensing unit (not shown). If the display direction of the first display mode of the user interface is different from the attitude of the display unit 120, after the first display mode shows the right display direction by the processing unit 130, x-axis, y-axis and z-axis of the sensor will be returned to the state before the rotation, and the extracted data will be transmitted back to the user interface directly for obtaining the correct data.

The desktop-like device 100 further includes a video lens. If the display direction of the first display mode of the user interface is different from the attitude of the display unit 120, after the first display mode shows the right display direction by the processing unit 130, the extracted image will be revised according the proportion of the display area and the display unit 120 by the processing unit 130, and counterclockwise or clockwise rotated in 90 degrees and enlarged to match the size of the display area for displaying the correct image.

When the user interface shown in portrait mode, the display mode can be switched into another display mode (landscape mode) by enabling the icon. On the other hand, when the user interface is shown in landscape mode, user can enable another icon for switching the display mode back to the portrait mode.

As described above, an embodiment of the invention provides a desktop-like device and a method for displaying a user interface. Even though the attitude of the display unit is different from the display mode of the user interface, the display mode can be shown in the correct mode to the user by pre-detecting and pre-processing by the processing unit; or the user can alter the user interface for showing the different mode easily by enabling an icon for providing better performance to user.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

1. A desktop-like device, comprising:
a detecting unit, detecting an attitude of the desktop-like device, and a first display mode of a user interface, wherein the first display mode provides a first long axis and a first short axis, and the first long axis is in predetermined proportion to the first short axis;
a display unit, providing a second long axis and a second short axis, and the user interface is shown in a display area by the first display mode;
a processing unit, determining whether the first display mode is compatible with the attitude or not, and if the first display mode is not compatible with the attitude, the first display mode will be displayed in the display area in predetermined proportion, and the first long axis will be equivalent to the second short axis, wherein the first long axis and the second short axis are parallel to each other.

2. The desktop-like device as claimed in claim 1, wherein the processing unit adjusts the first short axis of the first display mode according to the predetermined proportion.

3. The desktop-like device as claimed in claim 1, wherein the desktop-like device further comprises a sensing unit, and the sensing unit sets x-axis, y-axis and z-axis according to the attitude.

4. The desktop-like device as claimed in claim 1, wherein the desktop-like device further comprises a video lens, which further rotates at a predetermined angle according to the attitude.

5. The desktop-like device as claimed in claim 1, wherein the user interface further comprises an icon, and the processing unit displays a second display mode of the user interface according to the enablement of the icon.

6. A method for displaying a user interface, adapting to a desktop-like device, comprising:
detecting an attitude of the desktop-like device;
determining whether a first display mode of a user interface is compatible to the attitude or not, wherein the first display mode provides a first long axis and a first short axis, and the first long axis is in predetermined proportion to the first short axis;
adjusting the first display mode for being equivalent to the second short axis according to a predetermined proportion when the first display mode is not compatible with the attitude; and
displaying the user interface in a display area with the first display mode.

7. The method as claimed in claim 6, wherein the steps further comprises:
adjusting the first short axis of the first display mode according to the predetermined proportion.

8. The method as claimed in claim 6, wherein the desktop-like device further comprises a sensing unit, which sets x-axis, y-axis and z-axis according to the attitude.

9. The method as claimed in claim 6, wherein the desktop-like device further comprises a video lens, the video lens further rotates a predetermined angle according to the attitude.

10. The method as claimed in claim 6, wherein the user interface further comprises an icon, and the processing unit displays a second display mode of the user interface according to the enablement of the icon.
